(19) United States
(12) Patent Application Publication
(10) Pub. No.: US 2014/0114904 A1
(43) Pub. Date: Apr. 24, 2014

(54) SYSTEM FOR HEALTH MEDIA RECOMMENDATION BASED ON WELLBEING-INDEX

(71) Applicants: I-ONSOFT, INC., Seoul (KR); HANWHA SOLUTION & CONSULTING CO., LTD., Seoul (KR)

(72) Inventors: Hi Chul Choo, Seoul (KR); Kwang Kyun Kim, Seoul (KR); Heung Soo Park, Gyeonnggi-do (KR)

(73) Assignees: HANWHA SOLUTION & CONSULTING CO., LTD., Seoul (KR); I-ONSOFT, INC., Seoul (KR)

(21) Appl. No.: 13/662,836

(22) Filed: Oct. 29, 2012

(30) Foreign Application Priority Data
Oct. 24, 2012 (KR) 10-2012-0118714

(51) Int. Cl. G06N 5/02

(52) U.S. Cl. 706/50

(57) ABSTRACT

A system for providing health information is provided. The system includes a wellbeing-index (WI) providing unit and a recommendation media providing unit. The WI providing unit receives a user's health information obtained through one or more health information measuring devices and calculates a WI indicating the user's health condition based on the health information. The recommendation media providing unit provides a recommendation media content suitable for the user based on the WI providing unit.

### CROSS-REFERENCE TO RELATED APPLICATION

This application claims the benefit of Korean Patent Application No. 10-2012-0118714, filed on Oct. 24, 2012 in the Korean Intellectual Property Office, the disclosure of which is incorporated herein by reference.

### BACKGROUND

1. Field of the Invention

The present invention relates to a system for providing health information.

2. Description of the Related Art

As interest in health is increased, many technologies for more effective health care have recently been studied.

Biometric information measuring devices capable of obtaining information related to individual health conditions have continuously developed. However, the biometric information measuring device can extract only a predetermined portion of user's health information.

Various health indices have been developed and used to provide a user's health information. A health index provides data enabling specifying of a particularly problematic part in a user's health condition.

### SUMMARY

According to an aspect of the present invention, there is provided a system for providing health information, the system including a wellbeing-index (WI) providing unit to receive a user's health information obtained through one or more health information measuring devices and to calculate a WI indicating the user's health condition based on the user's health information, and a recommendation media providing unit to provide a recommendation media content suitable for the user based on the WI.

The recommendation media providing unit may include a keyword manager to extract an appropriate health keyword based on the WI, a media manager to provide media content information related to health, and a mapping agent to determine and provide a recommendation media according the user's WI based on mapping between the health keyword and the media content information.

The keyword manager may include a wellbeing data converter to convert the health keyword into data suitable for extraction by analyzing the WI, a wellbeing keyword provider to provide one or more candidate keywords which can be used to extract a data related to health, and a keyword extractor to extract an appropriate candidate keyword selected from the one or more candidate keywords as the health keyword by using the converted data.

The media manager may include a media content provider to provide the media content information, a metadata extractor to extract a metadata from the media content information, and a metadata decomposer to decompose the extracted metadata and to transmit the decomposed metadata to the mapping agent.

The mapping agent may include a keyword receiver to receive the health keyword from the keyword manager, a keyword analyzer to generate a media information request data for requesting media information by using the received health keyword, an inquiry extractor to extract an inquiry list appropriately corresponding to the media information request data; an inquiry creator to create a media recommendation inquiry for specifying a media content that is a recommendation object based on the inquiry list, a media transmitter to transmit the media recommendation inquiry to the media manager and to receive a recommendation content metadata that is a metadata of the media content corresponding the media recommendation inquiry from the media manager, and a metadata mapper to determine a recommendation media content by matching an optimal media content corresponding to the WI, using the health keyword and the recommendation content metadata.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for providing health information according to an embodiment of the present invention; and

FIG. 2 is a structural diagram illustrating components of a recommendation media providing unit of FIG. 1.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

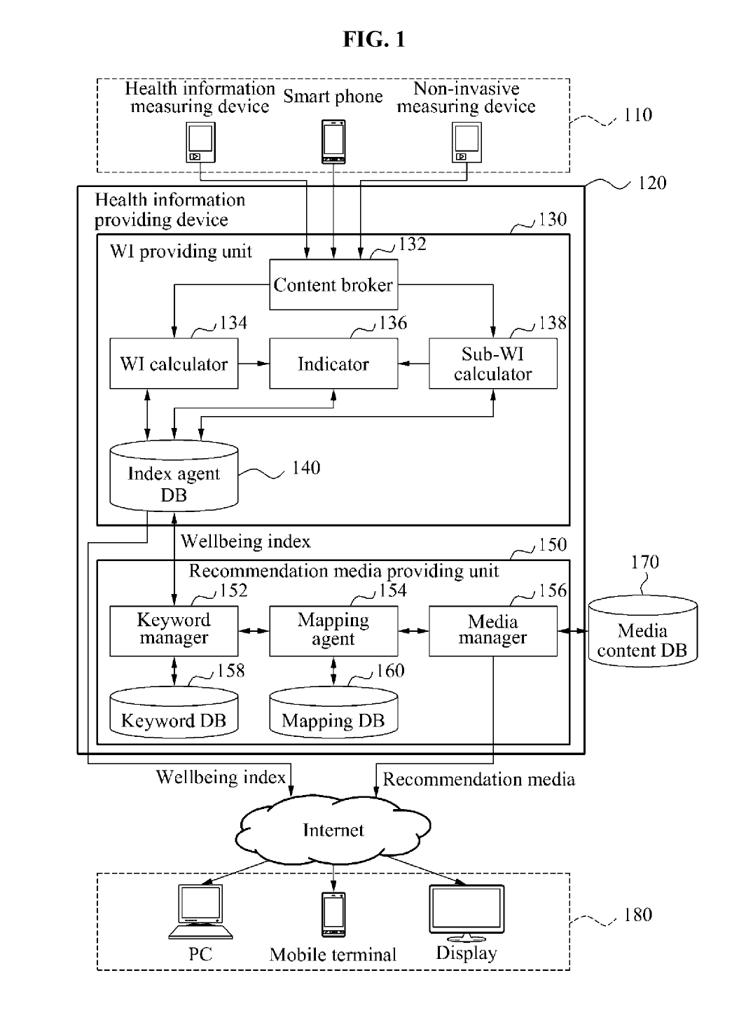

FIG. 1 illustrates a system 100 for providing health information according to an embodiment of the present invention.

Referring to FIG. 1, the system 100 according to the present embodiment includes a health information measuring device 110, a health information providing device 120, and a health information displaying device 180.

Hereinafter, the health information measuring device 110 will be described.

The health information measuring device 110 measures information related to a user's health to provide the measured health information.

The health information may include a user's biometric information, exercise information and survey information.

The biometric information may include information on a user's height, sex, age, weight, and the like.

The biometric information may include information on a user's blood pressure, heart rate, breathing rate, caloric consumption, body temperature, body fat content, body water content, stress degree, heart rate variability, acceleration pulse, and the like.

The exercise information may include information on kind of exercise performed by a user (e.g., running, cycling, swimming or the like), exercise time, exercise place, walk count, caloric intake, exercise quantity, and the like.

The survey information may include information on a user's answers for medical inquiries.

The medical inquiries may include information on a user's lifestyle habit such as an amount of smoking and an amount of drinks consumed, and information included in the biometric information and exercise information, for example, height, weight, amount of exercise, and the like, may also be obtained through the medical inquiries.

The health information measuring device 110 may include various devices, for example a smart phone, a non-intrusive measuring device, and the like, for generating and providing health information. For example, a user's exercise information may be provided by a global positioning system (GPS) and applications, which are built into the smart phone.

Hereinafter, the health information providing device 120 will be described.

The health information providing device 120 includes a wellbeing-index (WI) providing unit 130 and a recommendation media providing unit 150.

The WI providing unit 130 receives a user's health information obtained through the health information measuring device 110, and calculates and provides a WI indicating the user's health condition based on the received health information.

The WI indicates the user's health condition as an index.

For example, the WI may include one or more health indices that indicate a user's health condition in a specific field, such as a cardiovascular index, a stress index, a body mass index, and a health management index. Items of the WI indicate one or more specific health indices, respectively. That is, the WI may be data including health information for each field, calculated based on the health information.

The item of the WI may have various types. For example, the WI may include a body mass index and a management index as respective items. The body mass index may be a decimal fraction between 0 and 1, and the management index may have one of “upper,” “middle” and “lower” values.

The recommendation media providing unit 150 provides a recommendation media content suitable for a user based on the WI provided by the WI providing unit 130.

For example, for a user diagnosed with a serious problem in blood pressure based on a WI or a predetermined item in the WI, the recommendation media providing unit 150 may provide a media content including exercise or menu information for high blood pressure patients to the user.

Hereinafter, the WI providing unit 150 of the health information providing device 120 will be described.

The WI providing unit 150 may include a content broker 132, a WI calculator 134, an indicator 136, a sub-WI calculator 138, and an index agent database 140.

The content broker 132 receives health information from one or more health measuring devices 110.

The WI calculator 134 calculates a WI based on the health information.

For example, in a case where the WI includes a percentage of body fat (% BF) item, the % BF may be calculated by the following Equation 1.

% BF=(FM/W)×100(%) [Equation 1]

Here, FM denotes a body fat amount, and W denotes a weight.

Thus, the WI calculator 134 may calculate the % BF item that is one of WIs by using information indicating the body fat amount and information indicating the weight in the health information provided from the one or more health information measuring devices 110.

An item included in the WI may be used to calculate another item included in the WI.

For example, a body fat item may be calculated based on a weight and a lean body mass, and a % BF may be calculated based on the body fat item and the weight.

The sub-WI calculator 138 performs a sub-calculation necessary for the calculation of the WI.

For example, in a case where specific information of the heath information uses different units, for example kilogram (kg), pound (lb), and the like from each other so as to indicate mass, the sub-WI calculator 138 may convert a unit of a part of the specific information, so that the health information uses a unified unit.

For example, in a case where the health information includes a user's motion information, the sub-WI calculator 138 may generate information directly used to calculate a WI including a motion quantity, a motion distance, a motion time, and the like based on the motion information.

The indicator 136 generates an indicator using the WI generated by the WI calculator 134 and the information generated by the sub-calculation of the sub-WI calculator 138.

The indicator may indicate a situation of the WI, a change of the WI, or the like.

The indicator may be one obtained by converting a WI calculated by the WI calculator 134 into a grade.

The index agent database 140 stores a WI calculated by the WI calculator 134. Also, the index agent database 140 may store information calculated by the sub-WI calculator 138 as to provide the stored information to the WI calculator 134. Also, the index agent database 140 may store an indicator generated by the indicator 136.

The index agent database 140 may transmit the stored WI to an external device such as the health information display device 180, or the recommendation media providing unit 150.

Hereinafter, the recommendation media providing unit 150 of the health information providing device 120 will be described.

The recommendation media providing unit 150 may include a keyword manager 152, a mapping agent 154, a media manager 156, a keyword database 158, and a mapping database 160.

The keyword manager 152 extracts an appropriate keyword based on a WI.

For example, if a user's WI (or a specific item in the WI) indicates that the user is in a obese state, the keyword manager 152 may extract a health keyword as “fatness” or “obesity”.

The keyword database 158 provides a list of health keywords to be extracted by the keyword manager 152.

The media manager 156 provides information on media contents related to health.

The media manager 156 may receive information on media contents related to health from an external media content database 170 for storing a plurality of media contents.

The media content database 170 may be a component included in the health information providing system 120.

The mapping agent 154 performs an optimal mapping between the health keyword provided from the keyword manager 152 and the media content information provided from the media manager 156. A recommendation media according to the user's WI is determined based on the optimal mapping.

For example, in a case where the extracted health keyword is “fatness,” a media content including information on exercise methods for overweight people and foods for overweight people and the like may be determined as a recommendation media.

The mapping agent 154 may provide a recommendation media to the health information displaying device 180. Also, the mapping agent 154 may transmit information for identifying the recommendation media to the health information displaying device 180. The health information displaying device 180 may receive a recommendation media provided from the media content database 170 by using the information for identifying the recommendation media.

The mapping data base 160 provides information necessary for mapping between a health keyword and media content information. Thus, a flexible and configurable mapping is provided by the mapping agent 154.

Hereinafter, the health information displaying device 180 will be described.

The health information displaying device 180 receives a WI and a recommendation media from the health information providing device 120.

The health information displaying device 180 may receive a recommendation media from the media content database 170.

The health information displaying device 180 may display the provided WI or recommendation media to a user.

For example, the health information displaying device 180 may be an arbitrary device in which the WI or recommendation media can be displayed, such as a personal computer (PC), mobile terminal or display.

The health information providing device 120 may provide an application programming interface (API) for performing a transmission request, transmitting, reading, searching, or performing a display function of the WI or recommendation media. The API may be implemented in an XML form.

The health information displaying device 180 may access, read, search or display the WI or recommendation media using the API. The health information displaying device 180 may request for transmitting WI or recommendation media using the API.

The health information providing device 120 and the health information displaying device 180 may be connected to each other on an arbitrary wired/wireless network such as the Internet. The health information measuring device 110 and the health information displaying device 180 may also be connected to each other on an arbitrary wired/wireless network.

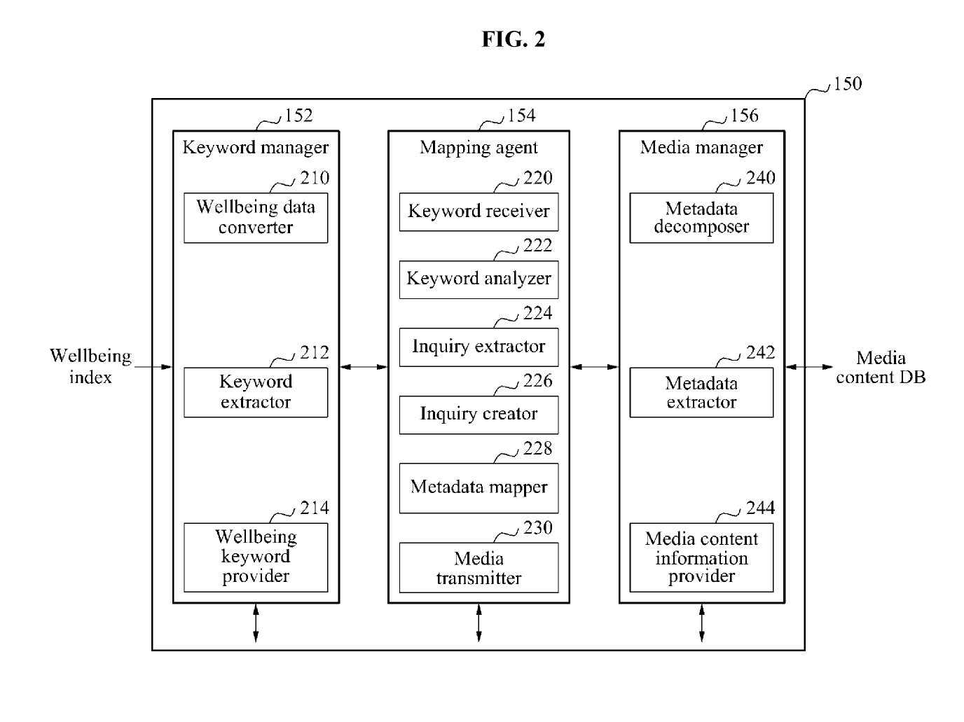

FIG. 2 is a structural diagram illustrating components of the recommendation media providing unit 150 of FIG. 1.

Among the components of the recommendation media providing unit 150, configurations of the keyword manager 152, the mapping agent 154, and the media manager 156 are further described with reference to FIG. 2.

The keyword manager 152 may include a wellbeing data converter 210, a keyword extractor 212, and a wellbeing keyword provider 214.

The wellbeing data converter 210 analyzes the transmitted WI and performs data conversion with respect to the WI for each item.

For example, in a case where the item of a blood pressure is configured as an integer value in a specific range, the wellbeing data converter 210 may convert the integer value indicating the blood pressure into a data suitable for extracting a health keyword such as a “high blood pressure” or “low blood pressure.”

The wellbeing keyword provider 214 provides one or more candidate keywords. The candidate keyword is a keyword refined so that data related to health can be extracted.

The wellbeing keyword provider 214 may provide different candidate keywords depending on an item.

The keyword extractor 212 extracts an appropriate keyword selected from the one or more candidate keywords provided by the wellbeing keyword provider 214 as a health keyword by using the converted data.

The media manager 156 may include a metadata decomposer 240, a metadata extractor 242 and a media content information provider 244.

The media content information provider 244 provides information on a media content related to health.

The media content information provider 244 may receive information on a media content from the external media content database 170.

The metadata extractor 242 extracts a metadata from a media content or information on the media content.

The metadata decomposer 240 decomposes the extracted metadata and transmits the decomposed metadata to the mapping agent 154.

The mapping agent 154 may include a keyword receiver 220, a keyword analyzer 222, an inquiry extractor 224, an inquiry creator 226, a metadata mapper 228, and a media transmitter 230.

The keyword receiver 220 receives a health keyword from the keyword manager 152.

The keyword analyzer 222 generates a media information request data for requesting media information by using the received health keyword.

The inquiry extractor 224 extracts an inquiry list appropriately corresponding to the media information request data. The inquiry list may one stored in the mapping database 160.

The inquiry creator 226 creates a media recommendation inquiry capable of specifying a media content to be a recommendation object based on the extracted inquiry list.

The media transmitter 230 transmits the created media recommendation inquiry to the media manager 156 and receives a recommendation content metadata that is a metadata of the media content corresponding to the media recommendation inquiry from the media manager 156.

The metadata mapper 228 performs mapping with respect to an optimal media content corresponding to the WI by using the health keyword and the received recommendation content metadata. A recommendation media content suitable for the user is determined by the mapping.

The metadata mapper 228 may perform the mapping based on one or more of a user's use pattern, a user's consumption pattern and metadata information.

The functions of the components 130 and 150 may be performed in a single control unit (not shown). Here, the control unit may be implemented as a single or multi chip, processor, or core. Each of the components and the subordinate components 130 to 170 and 210 to 244 may be implemented as a function, library, service, process, thread, or module performed by the control unit.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for health media recommendation based on a wellbeing-index (WI), the system comprising:
a WI providing unit to receive a user's health information obtained through one or more health information measuring devices and to calculate a WI indicating the user's health condition based on the user's health information; and
a recommendation media providing unit to provide a recommendation media content suitable for the user based on the WI,
wherein the user's health information comprises user's biometric information, exercise information and survey information, and
wherein the WI is data comprising health information for each field, calculated based on the user's health information.

2. The system of claim 1, wherein the WI providing unit comprises:
a content broker to receive health information from the one or more health measuring devices;
a WI calculator to calculate a WI based on the health information;
a sub-WI calculator to perform a sub-calculation necessary for calculation of the WI;
an indicator to generate an indicator using the WI generated(*calculated by the WI calculator and information generated by the sub-calculation of the sub-WI calculator, the indicator indicating a situation of a user's WI or a change of the user's WI; and
an index agent database to store the WI calculated by the WI calculator, information calculated by the sub-WI calculator, and the indicator generated by the indicator, and to transmit the stored WI to the recommendation media providing unit, or an external device to display health information.

3. The system of claim 1, wherein the recommendation media providing unit comprises:
a keyword manager to extract an appropriate health keyword based on the WI;
a media manager to provide media content information related to health; and
a mapping agent to determine and provide a recommendation media according the user's WI based on mapping between the health keyword and the media content information.

4. The system of claim 3, wherein the keyword manager comprises:
a wellbeing data converter to convert the health keyword into data suitable for extraction by analyzing the WI;
a wellbeing keyword provider to provide one or more candidate keywords which can be used to extract a data related to health; and
a keyword extractor to extract an appropriate candidate keyword selected from the one or more candidate keywords as the health keyword by using the converted data, and
wherein the media manager comprises:
a media content provider to provide the media content information;
a metadata extractor to extract a metadata from the media content information; and
a metadata decomposer to decompose the extracted metadata and to transmit the decomposed metadata to the mapping agent.

5. The system of claim 4, wherein the mapping agent comprises:
a keyword receiver to receive the health keyword from the keyword manager;
a keyword analyzer to generate a media information request data for requesting media information by using the received health keyword;
an inquiry extractor to extract an inquiry list appropriately corresponding to the media information request data;
an inquiry creator to create a media recommendation inquiry for specifying a media content that is a recommendation object based on the inquiry list;
a media transmitter to transmit the media recommendation inquiry to the media manager and to receive a recommendation content metadata that is a metadata of the media content corresponding the media recommendation inquiry from the media manager; and
a metadata mapper to determine a recommendation media content by matching an optimal media content corresponding to the WI, using the health keyword and the recommendation content metadata.
